(19) United States
(12) Patent Application Publication
(10) Pub. No.: US 2006/0075346 A1
(43) Pub. Date: Apr. 6, 2006

(54) Video presentation using compositional structures

(76) Inventors: Tom Lanning, Littleton, MA (US); Ajay Divakaran, Burlington, MA (US); Kadir Peker, Burlington, MA (US); Regunathan Radhakrishnan, Quincy, MA (US); Ziyou Xiong, Urbana, IL (US); Clifton L. Forlines, Cambridge, MA (US)

Correspondence Address: Patent Department;Mitsubishi Electric Research Laboratories, Inc., 201 Broadway, Cambridge, MA, 02139, US

(21) Appl. No.: 10/951,192

(22) Filed: Sep. 27, 2004

(51) Int. Cl. G11B 27/00

(52) U.S. Cl. 715/723

(57) ABSTRACT

A method presents a video according to compositional structures associated with the video. Each compositional structure has a label, and multiple segments that can be organized temporally or hierarchically. A particular compositional structure is selected with a remote controller, and the video is presented by a playback controller on a display device according to the compositional structure.

### FIELD OF THE INVENTION

This invention relates generally to presenting videos, and more particularly to presenting videos in a structured manner as controlled by a user.

### BACKGROUND OF THE INVENTION

Most older prior art devices, such as VCRs, present videos to a user according to a single compositional structure inherent in the temporal organized frames that can only be accessed sequentially on a linear tape. The modes of presentation are limited to play, reverse, pause, stop, fast forward, and fast reverse. Some VCRs allow the user to put index marks on the tape at arbitrary points along the video timeline. Then, the user can jump forward or backwards to the marks.

Newer prior art devices, such as DVDs, also provide prerecorded composition structures for the user, such as chapters and scenes, which are directly accessible. Additionally some DVDs provide alternative versions, e.g., cut and uncut versions, or versions in different languages. However, DVD players do not provide the user a simple uniform method of choosing and moving between these various composition structures. Typically, DVD players do not show how the various versions relate to the base video content.

Some very recent PVRs allow the user to generate compositional structures based on classified segments so that the user can play the video while skipping content, e.g., commercials.

### SUMMARY OF THE INVENTION

The invention provides a method and system for presenting a video using multiple compositional structures. A compositional structure identifies and labels segments of the video. Example compositional structures are a list of commercials in a comedy program, a list of story items in a news program, and a list of baseball batters in a sports program. The user can select dynamically any compositional structure, and then the video is presented according to the selected compositional structure.

### BRIEF DESCRIPTION OF THE DRAWINGS

FIG. 1 is a block diagram of a presentation system and method according to the invention;

FIG. 2 is a block diagram of a compositional structure according to the invention;

FIG. 3 is a block diagram of a video presentation according to the invention; and

FIG. 4 is a top view of a remote controller according to the invention.

### DETAILED DESCRIPTION OF THE PREFERRED EMBODIMENT

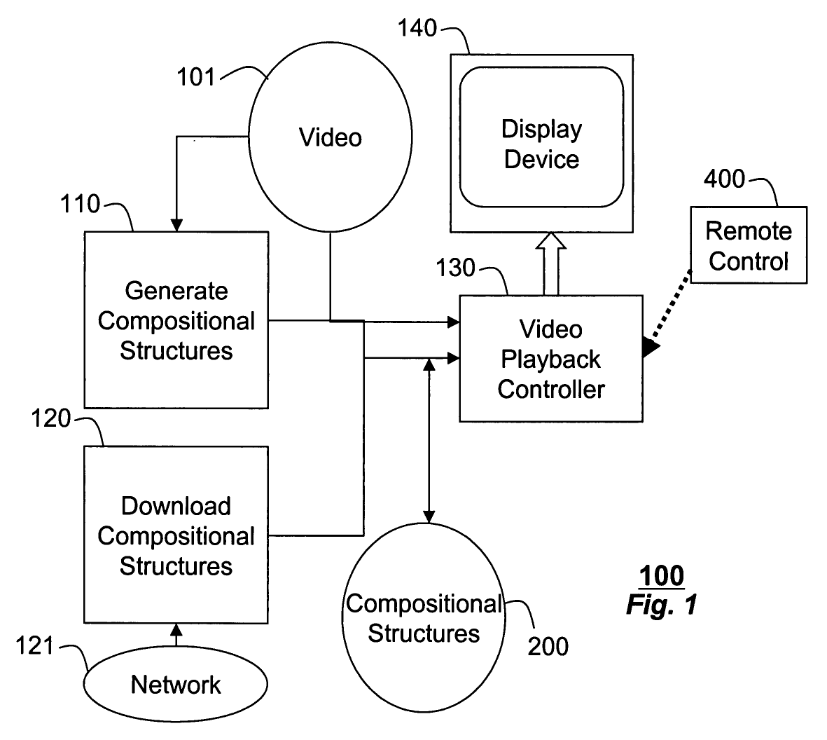

As shown in FIG. 1, the invention provides a method and system 100 for presenting a video 101 to a user according to compositional structures 200. The compositional structures can be generated 110 from the video 101 or downloaded 120 via a network 121, e.g., the Internet, from a remote location. A remote controller 400 selects particular compositional structures that determine dynamically how a playback controller 130 and a display device 140 present the video 101 to a user.

The compositional structures 200 can be generated 110 either locally by a feature extractor operating on audio and visual features of the video, or the structures are downloaded 120 from a remote location via the network 121. The compositional structures can be generated automatically or manually. The compositional structures can be stored in a memory, e.g., the same memory storing the video, or a memory of the presentation system 100, as described below in greater detail.

Compositional Structures

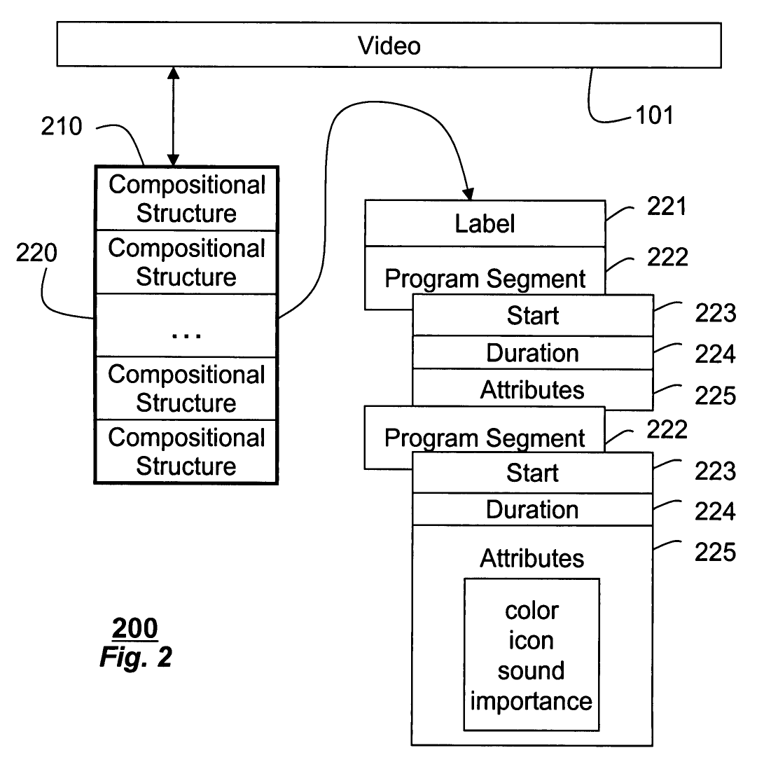

Generally, the compositional structures 200 shown in FIG. 2 can be simple, hierarchical, or compound.

For example, a simple structure partitions a conventional broadcast video into program segments and commercial segments. Similarly, a simple composition of a sports video includes play and break segments, e.g. pre-game, time-outs, and post-game segments, or just scoring opportunities. Another simple structure partitions the audio and visual portions.

A hierarchical composition of a baseball game video includes game and commercial segments, and within the game segments, innings, and within innings, batters, and within batters, pitches, and within pitches, base hits, and perhaps, within base hits, home runs.

A compound structure can use both simple and hierarchical compositions, e.g., the intersection of just the game without commercials, and further innings within the game.

A particular video can have multiple compositional structures, and the user can present the video according to different selected compositional structures. The selected compositional structure can change while the video is presented.

As shown in FIG. 2, the video 101 is associated with an ordered list 210 of compositional structures 220. Each compositional structure 220 includes a label 221, and a list of program segments 222. Each program segment is associated with a start 223, an optional duration 224, and a set of attributes 225.

The label 221 describes or ‘names’ the structure, e.g., “Red Sox vs. Yankees 9/13/04.” The label can be a text string, an image, an icon or a short video and/or audio clip. The program segments 222 can be ordered. The ordering can be according to time, subjective importance based on, for example, percentage of cheering, etc. The ordering can also be hierarchical, as described above.

The start 223 is a time or frame relative to the beginning of the video 101. The optional duration is the length of the segment in terms of time or frames.

The attributes 225 further identify each program segment. The attributes can be a color, icon, or sound that represents content specific information about the segment, such as this segment contains a “scoring play” or that the “crowd reaction was intense”. Relative importance is another possible attribute. Attributes can also include classifications.

Example Presentation

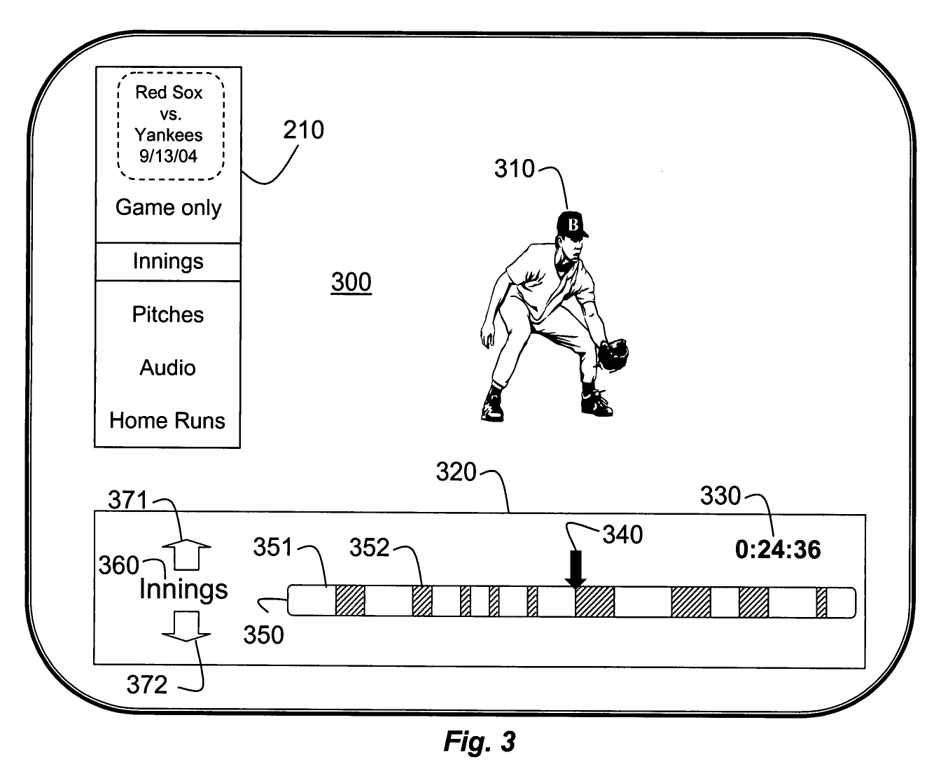

FIG. 3 shows an example presentation 300. The presentation includes content 310, and a presentation control window 320. The window 320 includes the video time 330, relative to the beginning of the video, and a position marker 340, which shows a current position within the video. A segment bar 350 includes inactive segments 351 and active segments 352, according to the currently selected compositional structure. The label 360 identifies the compositional structure, and the up-down arrows 371-372 show if there are next (down) or previous (up) compositional structures available from the list 210 of compositional structures.

The list 210 of available compositional structures 200 can also describe the content. Examples of such structures include highlights in a sports video, program-only segments, pitches in baseball, home runs, etc.

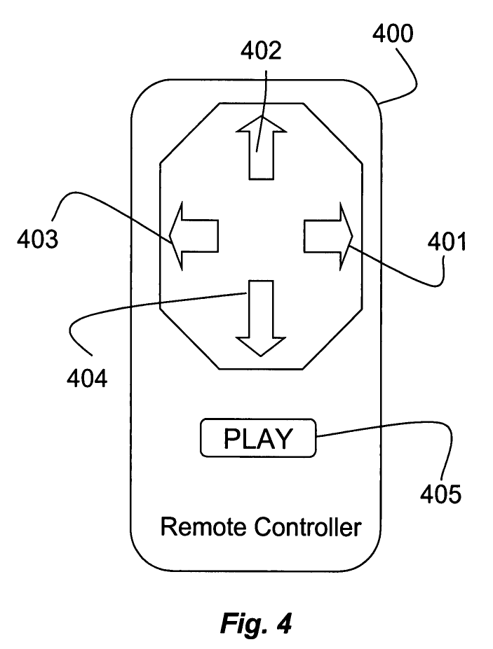

As shown in FIG. 4, the list can be scrolled using the up-down arrow pair 402 and 404 on the remote controller 400. After the compositional structure has been selected, the playback controller 130 presents the video on the display device 140 according to the selected compositional structure, skipping over inactive segments of the video that are not part of the selected compositional structure. The user can also use the left-right arrow pair 403 and 401 to move the arrow 340 to position the video to the beginning of any segment within the current compositional structure. The remote controller also includes a play button 405.

It should be noted, the remote controller according to the invention only has five buttons, to give the user a much greater control of the presentations than prior art devices with many more buttons.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for presenting a video, comprising:
associating a plurality of compositional structures with a video, each compositional structure having a label and a plurality of segments, each segment having an associated start;
selecting a particular compositional structure;
presenting the plurality of segments of the video according to the selected compositional structure on a display device; and
displaying the particular compositional structure, including the label and the starts of the plurality of segments on the display device while presenting the video.

2. The method of claim 1, in which the selecting further comprises:
traversing a list of labels of the compositional structures using a remote control device; and
indicating the particular compositional structure using the remote control device.

3. The method of claim 1, in which each program segment is further associated with a duration and attributes.

4. The method of claim 1, in which the plurality of segments are organized temporally.

5. The method of claim 1, in which the plurality of segments are organized hierarchically.

6. The method of claim 1, in which another compositional structure is selected dynamically while presenting the particular compositional structure, and displaying the particular compositional structure.

7. The method of claim 1, in which the particular compositional structure is displayed in a control window.

8. The method of claim 7, in which the control window shows a current time of the video relative to a beginning of the video, and a current position marker of the video relative to the plurality of segments.

9. The method of claim 8, further comprising:
moving the position marker to an arbitrary position in the video; and
presenting the video beginning at the arbitrary position.

10. The method of claim 1, in which the plurality of segments include active segments and inactive segments, and further comprising:
displaying only the active segments on the display device; and
skipping over the inactive segments.

11. A system for presenting a video, comprising:
a memory configured to store a plurality of compositional structures, each compositional structure associated with a video, each compositional structure having a label, and a plurality of segments;
a remote controller configured to select a particular compositional structure;
a playback controller configured to present the video according to the compositional structure on a display device; and
means for displaying the particular compositional structure, including the label and the active segments and the inactive segments, on the display device while presenting the video.
